(19) United States
(12) Patent Application Publication
(10) Pub. No.: US 2002/0165637 A1
(43) Pub. Date: Nov. 7, 2002

(54) Method for highly automated manufacture of metal parts

(76) Inventor: Kelly Dillon, Ellensburg, WA (US)

Correspondence Address: Kelly Dillon, 352 Susan Rd., Ellensburg, WA, 98926, US

(21) Appl. No.: 09/851,207

(22) Filed: May 7, 2001

(51) Int. Cl. G06F 19/00

(52) U.S. Cl. 700/162; 700/182

(57) ABSTRACT

A method, using computer aided design logic and apparatus for part design, representation and fabrication. The system uses standard EDM technology to remove metal. The EDM anodes are provided in a variety of cross sectional shapes and their working ends are automatically shaped by the system to standard shapes in order to remove subsections of metal to shape the desired part. Anode positioning is attained by the use of a multi-axis positioning robot to move either part or cutter or both, with up to five degrees of relative motion. Through the use of the computer system and the automatic creation of the cutting tools, all cut “operations” can be performed with minimal operator assistance, on one machine, in typically one or two part holds. The raw material is considered as comprising two groups of particles. One group is removed to produce the part. The other group comprises the part.

### BACKGROUND OF THE INVENTION

1. Field

The subject invention is in the fields of machines, systems and apparatus used for machining and prototyping tools for metalworking.

2. Prior Art

No prior art was found relating to this machining system, though numerous existing devices and technologies are used in this system. Existing devices include robotic or computer numerically controlled (CNC) milling and positioning machines, electrical discharge machining (EDM) machines, Computer Aided Design (CAD) software systems, and Computer Aided Manufacturing (CAM) software systems. While these systems have all been developed in many ways, none have succeeded in effecting any highly automated method of milling metal parts. To fabricate a metal part, any number of these systems must be employed separately and in various sequences to complete all design and all milling operations. The requirement for multiple operations and multiple (typically expensive) machines greatly increases the product cost. Also, each step requires professional operator interaction, which also increases cost as well as increases the chance of error. Costs are further increased by the needs for each of various cutting tools, which include but are not limited to mill and lathe cutters and custom shaped EDM cutting devices called “anodes”.

The integration of CAD/CAM systems with CNC milling machines has greatly reduced costs and errors, but a high degree of operator oversight is still required. Plus, system setup for each operation remains a complex process of computer simulating the driving of cutter tools over CAD parts and then translating those paths into CNC language.

A further complexity which stems from modern machining processes is that the price to manufacture parts must often be carefully quoted, which process can be time consuming since each machining operation must be accurately estimated. Also the time to machine a product is extended not only by the multiple operations, but also by the availability of the machines and machine operators. Keeping a part moving fluidly through the required operations in a conventional, up-to-date machine shop is a complex and time consuming planning and estimating process.

Accordingly, the primary objective of this invention is to provide a method and apparatus which employs known technologies in an integrated fashion which highly automates the process of making a part from start to finish. Another objective is to provide a manufacturing method and apparatus which (1) enables doing all manufacturing with one tool and (2) costs much less than the combined costs of conventional machines providing capability equivalent to that provided by the subject invention. Further objectives are that (3) the manufacturing be safer; (4) not require specially purchased cutters or custom preformed anodes; (5) allow the use of simpler CAD/CAM systems so that computer setup is simpler, more reliable and faster; (6) allow simpler and easier planning and estimating so that cost quoting time, effort and chance for error are reduced; (7) eliminate the need for hardening and finishing after machining of hardened material; (8) allow most of the work to be done by computer; (9) allow repeat manufacture, changes and rework almost fully automatically; and (10) avoid high machining forces, thus eliminating the ill effects and extra work necessitated by machine deflections and resulting in accuracy not affected by machining forces, longer tool life and smaller, less expensive tooling.

### SUMMARY OF THE INVENTION

The subject invention is a method for machining to produce metal parts from pieces of raw material (metal “blanks”). The fundamental principle on which the system is based is that the raw material is considered as being comprised of two sets of particles. A first set is the particles which make up the part to be produced. The second set is the particles of raw material to be removed, i.e. separated from the raw material to produce the part.

For purposes of this disclosure the term milling means removal of material. The apparatus which embodies the subject method consists of a multi-axis positioning robot having typically three to five degrees of freedom of position control, plus one to three axes of position control for a cutter head. The positioning robot is used to control the positions of the part and cutter head relative to each other. The positioning axes may be attached in any combination to either the metal part or to the cutter. For example the part may be static and the cutter may be on the end of a five-axis arm, or the part may be mounted to two rotational axes connected in series, with the cutter connected to a separate three-axis linear xyz positioning system. Cutter head control provides proper orientation of the cutter relative to the surface being cut.

The cutter is an electrical discharge machining (EDM) anode. It is not pre-shaped in the form of a negative of part of the metal part, as is done in conventional EDM work, but rather it is shaped into any of several fundamental shapes, such as a round dowel, a square, a triangle, a ball, a tear-drop, etc. The working ends of the anodes are shaped by the apparatus itself. The machine center automatically grasps any of several anodes such as square or round rods, then holds these raw anodes up to sanding wheels and milling tools (which are spinning but otherwise statically fixed to the positioning system) to shape the working ends of the anodes to the desired fundamental shapes. Because anodes wear as they are used, the same shaping process can be repeated to correct for wear. Automated camera systems or other sensor devices are used to check the accuracy and positions of the anode shapes formed. These formed anodes are used to mill the metal part as needed. The variety of shapes enables the system to produce even the most complex parts. Some parts can be created which were to-date not machinable as a single part, such as a part with a small bore with a tapped holed perpendicular to the bore, inside the bore. As with normal EDM processes, the part is flooded with oil as the EDM is in process.

The machining center is completely controlled by a computer with a multi-axis control system. The control is linked directly to a CAD/CAM system customized for this system. While many typical CAD features are employed in the system, several new components are used which simplify the system and make it more robust for all milling operations.

One such component involves the way the part “exists” in CAD. Whereas most CAD systems of today “think” of parts in terms of lines and surfaces, or alternately as solids, this system “thinks” of the raw material as two groups of particles, one group to be removed and the other to remain to form the part. The resolution (size) of the particles goes down to roughly a magnitude below the level of milling resolution—if the accuracy of the part is 0.001 inches, then the system will resolve the raw material to particles in the range of 0.0005 inches. Note that not all particles are “created” in the CAD system at any one time. Particles are unified in logical groups until access to them is required for design work, display, or milling planning.

Another feature is the milling logic. In most CAM systems machine control is thought of in terms of cutter paths relative to the metal part—usually involving cutters of specific shapes traveling along surfaces or logically removing pockets of metal, which pockets are constrained by surfaces, lines, or solids. While this system uses similar logic, it is simplified by reducing the part to simply particles of all the same size and property—a point of the smallest resolution size. Thus the logic system is simplified in that multiple shapes and geometry need not be analyzed and alternately milled or avoided. In that the cutters themselves are considered particles (albeit hollow), the system logic is vastly reduced to merely making sure that cutter particles don't take up the same space where metal is to remain, and that cutter particles don't try to remove too many layers of particles at any one time.

The system is further simplified by the third feature, which is the operator interface for constructing a milling “path” of particle removal. Other systems attempt to assist the operator in automated processes and paths. This inevitably leads to increased system complexity and the need for additional operator expertise. The subject system targets minimizing the need for system complexity and operator expertise by allowing the operator to simply walk the cutter (in the computer) through the particle groups which must be removed. Logically the operator need not touch every particle, but must select an appropriate cutter shape (and scale) and cause that tool to pass through every particle group without removing any of the “part” particles—thereby providing the system with a logical path to reach all points to be removed. The system then automates the removal of the particle groups. Cutter speed, cutter finish, and electrical properties of the EDM system are computer controlled to achieve maximum speed for non-finish work and desired surface quality for finish work. Additional cutter path automation may be added as desired.

To list the new components in CAD used in the embodying apparatus:

1. Part shaping logic/format (the part as two groups of particles).

2. Milling logic (just particle removal).

3. Building the milling “Path” (touching on particle groups and indicating particle groups to avoid).

The basic novelty of the subject method and related apparatus is summarized as follows: In conventional EDM milling work the anodes have specially shaped cross sections, shaped to produce shaped surfaces of the parts being manufactured. Further, the motion of the anode is rectilinear, i.e. there is one degree of freedom between the anode and the raw material from which the part is being made.

In the subject method and related apparatus, an array of anodes is provided, each having a particular cross sectional shape such as a circle, square or rectangle; the ends of the anodes are specially shaped and there are up to five degrees of freedom between the end of the anode and the raw material from which a part is being made.

With the anodes configured and maneuvered according to this method, portions of particles of the raw material, with particle size related to the desired detail shapes and tolerances and finish of the part, are removed to leave the portion of particle which comprises the part.

One physical embodiment of the apparatus consists of the milling machine in a box enclosure on a table with the EDM electrical equipment enclosed under the table. The computer control equipment and monitor are enclosed in an industrial type cabinet to the one side of the milling machine. The operator's computer keyboard and pointing device are mounted in a collapsible tray below the monitor in the cabinet.

The subject method comprises the steps of:

a) providing a plurality of part grasping devices, each having multiple axes of motion,

b) providing a table,

c) defining in CAD both a part blank and a plurality of anode blanks, all said blanks comprising three dimensional arrays of particles, each of said particles occupying a specific cubic volume of measurable space, each of said part blanks having an effective surface,

d) creating in each of said part blanks a CAD part by selecting a subset of said particles in said part blank which subset comprises said CAD part,

e) creating in CAD a sequential motion of one of said plurality of part grasping devices such that it takes hold of each of said part blanks from said plurality of part blanks and places each of said part blanks on said table in a specific position, said sequential motion being restricted to motions that can be replicated in the physical world using said EDM machinery,

f) creating in said plurality of anode blanks, a plurality of custom CAD anodes by selecting in each of said anode blanks a subset of said blank particles to form each of said custom anodes,

g) creating in CAD a sequential motion for one of said plurality of part grasping devices with multiple axes of motion, such that it takes hold of one of said anode blanks from said plurality of anode blanks, said sequential motion being restricted to motions that can be replicated in the physical world using said EDM machine,

h) using said one of said plurality of part grasping devices to individually and sequentially move each of said anode blanks against CAD surfaces, which surfaces, when contacted with said anode blanks, remove particles so as to create said custom CAD anodes, said sequential motions being restricted to motions that can be replicated in the physical world using said EDM machine,

i) using said one of said plurality of part grasping devices, individually and sequentially moving each of said custom CAD anodes around and into each of said CAD blanks so as to come in contact with and thereby incrementally remove particles in each of said CAD blanks that are not part of said part subcomponent, wherein particles are removed only when they are on said effective surfaces of the remaining particles of each of said part blanks, said sequential motions being restricted to motions that can be replicated in the physical world using said EDM machine, for the purposes of removing metal to form a physical part,

j) using CAM software controls to define timing, frequency and voltage of electrical discharges in context of said anode motion relative to each of said part blanks so as to effect particle removal at desired removal rates and thereby create desired finishes,

k) creating sequential motion in CAD of one of said plurality of part grasping devices to reposition said part blank for additional particle removal and repetition of steps e-j,

l) creating sequential motion in CAD of said at least one part-grasping device to remove said part from said table and release said part,

m) composing all said sequential motions into a single CAM machine sequence such that the placement of each of said part blanks, the selection of and shaping of each of said anode blanks into custom anodes and the motion of each of custom anodes about said part blanks all occur in a sequence logical to the automatic creation of said metal parts,

n) translating said CAM machine sequence to commands for use in said EDM machine,

o) sending said CAM machine sequence to said EDM machine,

p) sending the shapes of each of said custom anodes to said EDM machine,

q) providing physical anode blanks having shapes as represented by said CAD anode blanks, and initial positions and locations relative to said CAD and at least one of said plurality of part grasping devices,

r) placing said physical anode blanks into said EDM machine in said initial locations and positions relative to said CAD and said plurality of part grasping devices,

s) providing physical part blanks having shapes as represented by said CAD part blanks and having initial locations and positions relative to said CAD and said at least one of said plurality of grasping devices,

t) placing said physical part blanks into said EDM machine in said initial locations and positions relative to said CAD and one of said part grasping devices,

u) running said EDM machine per said CAM machine sequence, interrupting the sequence after the custom creation of any anode to use digital imaging systems to compare the shapes of the anodes against the CAD anode shapes, and rework or discard anodes if necessary.

### BRIEF DESCRIPTION OF THE DRAWINGS

FIG. 1 is an isometric view of a physical embodiment of the subject method.

FIG. 2 illustrates the internal components of the EDM milling apparatus.

FIG. 3 illustrates a cutting tool in the process of removing particles and leaving particles which form the part.

FIG. 4 illustrates a CAD part comprised of particles, with a CAD cutter being moved by the operator through a region of particles to be removed.

### DETAILED DESCRIPTION OF THE INVENTION

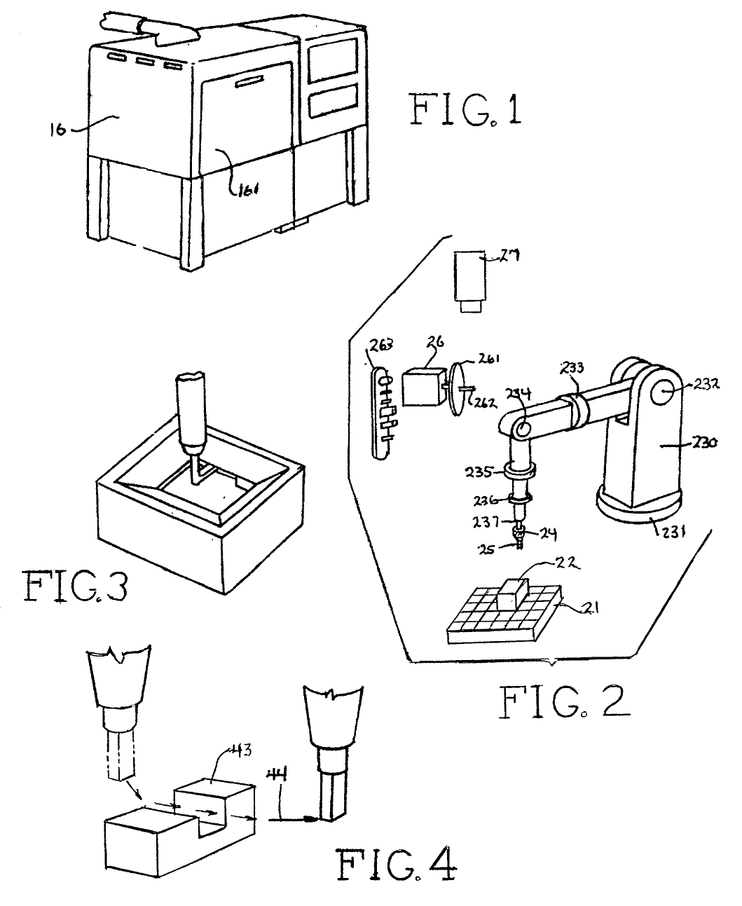

Referring to FIGS. 1, 2, 3 and 4, the apparatus which embodies the subject method is operated according to the method and comprises a computer software system 11 which allows the operator to define a piece of raw metal material (a blank) 22, (a block of metal of some typical geometric shape such as a cube or cylinder), and within that blank, a metal machinable part 43 in three-dimensional computer data space. The operator defines cutting paths such as seen in 44 for removal of metal from the part. The computer calculates any number of required cutting paths and then, on a per-path basis, automatically calculates specific anode cross section and working end shapes for cutting along the required paths. The operator verifies the creation of these paths and anode shapes, and alters any which are not deemed correct.

The operator may then locate metal blank 22 on part holder 21. All components in FIG. 3 are located inside the EDM milling station 16, behind door 161, with anode supply stock holder 263, anode shaper 26, and camera 27 located well above the part and part holder. The operator closes door 161 and initiates the automated process. The anode is attached to robotic arm 230, which has a plurality of synchronously controlled axes 231-237. The computer controls the robot arm in all described procedures. The first automated procedure is the creation of an anode. The robot arm moves chuck 24 to select a piece of anode stock from anode stock supply 263. The working end shape of anode 25 is created by the robotic arm moving the anode about the cutting devices 261-262 mounted to shaping machine 26. The created anode may be digitally verified for end shape accuracy using camera 27 in conjunction with the motion of the robotic arm. The first anode created is used for locating the position of the raw material. The robotic arm moves the anode to the vicinity of the material and locates the material edges by sensing voltage drops through the anode as the anode gets extremely close to the material. With the location known the part may be cut using either the existing anode, or by the creation of new anodes custom made for each milling path.

The station is automatically flooded with oil, sufficient to immerse the part but not the anode shaper and supply stock. The computer control system then positions the anode correctly relative to the part for the gradual EDM burning process. As metal is removed from the part the anode will wear. This wear may be automatically compensated for via the computer controls, or the anode may be automatically reshaped with the anode shaper. Electrical power for the EDM process is supplied by the EDM electrical components 15. Oil is cycled through the burning area and is filtered by system 14.

If additional cuts are required on the part which cannot be reached by the part in its initial position (such as cuts on the bottom of the part) then the part may be repositioned on the part holder for the additional required cuts.

The subject method comprises the steps of:

a) providing a plurality of part grasping devices, each having multiple axes of motion,

b) providing a table,

c) defining in CAD both a part blank and a plurality of anode blanks, all said blanks comprising three dimensional arrays of particles, each of said particles occupying a specific cubic volume of measurable space, each of said part blanks having an effective surface,

d) creating in each of said part blanks a CAD part by selecting a subset of said particles in said part blank which subset comprises said CAD part,

e) creating in CAD a sequential motion of one of said plurality of part grasping devices such that it takes hold of each of said part blanks from said plurality of part blanks and places each of said part blanks on said table in a specific position, said sequential motion being restricted to motions that can be replicated in the physical world using said EDM machinery,

f) creating in said plurality of anode blanks, a plurality of custom CAD anodes by selecting in each of said anode blanks a subset of said blank particles to form each of said custom anodes,

g) creating in CAD a sequential motion for one of said plurality of part grasping devices with multiple axes of motion, such that it takes hold of one of said anode blanks from said plurality of anode blanks, said sequential motion being restricted to motions that can be replicated in the physical world using said EDM machine,

h) using said one of said plurality of part grasping devices to individually and sequentially move each of said anode blanks against CAD surfaces, which surfaces, when contacted with said anode blanks, remove particles so as to create said custom CAD anodes, said sequential motions being restricted to motions that can be replicated in the physical world using said EDM machine,

i) using said one of said plurality of part grasping devices, individually and sequentially moving each of said custom CAD anodes around and into each of said CAD blanks so as to come in contact with and thereby incrementally remove particles in each of said CAD blanks that are not part of said part subcomponent, wherein particles are removed only when they are on said effective surfaces of the remaining particles of each of said part blanks, said sequential motions being restricted to motions that can be replicated in the physical world using said EDM machine, for the purposes of removing metal to form a physical part,

j) using CAM software controls to define timing, frequency and voltage of electrical discharges in context of said anode motion relative to each of said part blanks so as to effect particle removal at desired removal rates and thereby create desired finishes,

k) creating sequential motion in CAD of one of said plurality of part grasping devices to reposition said part blank for additional particle removal and repetition of steps e-j,

l) creating sequential motion in CAD of said at least one part-grasping device to remove said part from said table and release said part,

m) composing all said sequential motions into a single CAM machine sequence such that the placement of each of said part blanks, the selection of and shaping of each of said anode blanks into custom anodes and the motion of each of custom anodes about said part blanks all occur in a sequence logical to the automatic creation of said metal parts,

n) translating said CAM machine sequence to commands for use in said EDM machine,

o) sending said CAM machine sequence to said EDM machine,

p) sending the shapes of each of said custom anodes to said EDM machine,

q) providing physical anode blanks having shapes as represented by said CAD anode blanks, and initial positions and locations relative to said CAD and at least one of said plurality of part grasping devices,

r) placing said physical anode blanks into said EDM machine in said initial locations and positions relative to said CAD and said plurality of part grasping devices,

s) providing physical part blanks having shapes as represented by said CAD part blanks and having initial locations and positions relative to said CAD and said at least one of said plurality of grasping devices,

t) placing said physical part blanks into said EDM machine in said initial locations and positions relative to said CAD and one of said part grasping devices,

u) running said EDM machine per said CAM machine sequence, interrupting the sequence after the custom creation of any anode to use digital imaging systems to compare the shapes of the anodes against the CAD anode shapes, and rework or discard anodes if necessary.

It is considered to be understandable from this description that the subject invention meets its objectives. It provides a method which enables virtually complete automation of the making of a metal part. All the manufacturing can be done with one tool and costs are considerably less than the costs using conventional methods and apparatus. No specially purchased cutters or anodes with custom shaped cross section shapes are required. The method enables use of simpler CAD/CAM systems, making the computer set up simpler, more reliable and faster. Planning and estimating are simpler and easier so that cost quoting time, effort and chances for error are reduced. Hardened material can be used as raw stock so that no hardening after milling or finishing after hardening are required. Repeat manufacture, changes and reworking can be done fully automatically except for minimal initial and final part handling. Also, there are no high forces involved in the milling, thus eliminating the negative effects and extra work caused by machine part deflections during manufacture. Desired levels of accuracy are more easily achieved; tooling is smaller and less expensive and tool life is longer.

It is also considered to be understood that while a certain method is disclosed herein, other methods and modifications of the one described are possible within the scope of the invention which is limited only by the attached claim.

I claim:

1. A method of using Computer Aided Design (CAD), Computer Aided Manufacturing (CAM) and Electrical Discharge Machining (EDM) machinery having multiple axes of motion between the electrical discharge anode and the metal to be cut, to simplify and automate the mechanical process of creating or modifying machinable metal parts, said process comprising the steps of:
a) providing a plurality of part grasping devices, each having multiple axes of motion,
b) providing a table,
c) defining in CAD both a part blank and a plurality of anode blanks, all said blanks comprising three dimensional arrays of particles, each of said particles occupying a specific cubic volume of measurable space, each of said part blanks having an effective surface,
d) creating in each of said part blanks a CAD part by selecting a subset of said particles in said part blank which subset comprises said CAD part,
e) creating in CAD a sequential motion of one of said plurality of part grasping devices such that it takes hold of each of said part blanks from said plurality of part blanks and places each of said part blanks on said table in a specific position, said sequential motion being restricted to motions that can be replicated in the physical world using said EDM machinery,
f) creating in said plurality of anode blanks, a plurality of custom CAD anodes by selecting in each of said anode blanks a subset of said blank particles to form each of said custom anodes,
g) creating in CAD a sequential motion for one of said plurality of part grasping devices with multiple axes of motion, such that it takes hold of one of said anode blanks from said plurality of anode blanks, said sequential motion being restricted to motions that can be replicated in the physical world using said EDM machine,
h) using said one of said plurality of part grasping devices to individually and sequentially move each of said anode blanks against CAD surfaces, which surfaces, when contacted with said anode blanks, remove particles so as to create said custom CAD anodes, said sequential motions being restricted to motions that can be replicated in the physical world using said EDM machine,
i) using said one of said plurality of part grasping devices, individually and sequentially moving each of said custom CAD anodes around and into each of said CAD blanks so as to come in contact with and thereby incrementally remove particles in each of said CAD blanks that are not part of said part subcomponent, wherein particles are removed only when they are on said effective surfaces of the remaining particles of each of said part blanks, said sequential motions being restricted to motions that can be replicated in the physical world using said EDM machine, for the purposes of removing metal to form a physical part,
j) using CAM software controls to define timing, frequency and voltage of electrical discharges in context of said anode motion relative to each of said part blanks so as to effect particle removal at desired removal rates and thereby create desired finishes,
k) creating sequential motion in CAD of one of said plurality of part grasping devices to reposition said part blank for additional particle removal and repetition of steps e-j,
i) creating sequential motion in CAD of said at least one part-grasping device to remove said part from said table and release said part,
m) composing all said sequential motions into a single CAM machine sequence such that the placement of each of said part blanks, the selection of and shaping of each of said anode blanks into custom anodes and the motion of each of custom anodes about said part blanks all occur in a sequence logical to the automatic creation of said metal parts,
n) translating said CAM machine sequence to commands for use in said EDM machine,
o) sending said CAM machine sequence to said EDM machine,
p) sending the shapes of each of said custom anodes to said EDM machine,
q) providing physical anode blanks having shapes as represented by said CAD anode blanks, and initial positions and locations relative to said CAD and at least one of said plurality of part grasping devices,
r) placing said physical anode blanks into said EDM machine in said initial locations and positions relative to said CAD and said plurality of part grasping devices,
s) providing physical part blanks having shapes as represented by said CAD part blanks and having initial locations and positions relative to said CAD and said at least one of said plurality of grasping devices,
t) placing said physical part blanks into said EDM machine in said initial locations and positions relative to said CAD and one of said part grasping devices,
u) running said EDM machine per said CAM machine sequence, interrupting the sequence after the custom creation of any anode to use digital imaging systems to compare the shapes of the anodes against the CAD anode shapes, and rework or discard anodes if necessary.
